(19) United States
(12) Patent Application Publication
(10) Pub. No.: US 2026/0038745 A1
(43) Pub. Date: Feb. 5, 2026

(54) DISPERSION FOR USE IN MANUFACTURING ELECTROLYTIC CAPACITOR, ELECTROLYTIC CAPACITOR MANUFACTURING METHOD, AND ELECTROLYTIC CAPACITOR

(71) Applicant: Panasonic Intellectual Property Management Co., Ltd., Osaka (JP)

(72) Inventors: Yukiya SHIMOYAMA, YAMAGUCHI KEN (JP); Tomoyuki TASHIRO, YAMAGUCHI KEN (JP); Shumpei MATSUSHITA, YAMAGUCHI KEN (JP); Honami KOJIMA, OSAKA FU (JP)

(21) Appl. No.: 18/997,747

(22) PCT Filed: Jul. 27, 2023
(86) PCT No.: PCT/JP2023/027569

§ 371 Date: Jan. 22, 2025

(30) Foreign Application Priority Data
Jul. 29, 2022 (JP) 2022-121573

(51) Int. Cl. H01G 9/07; H01G 9/00

(52) U.S. Cl. CPC H01G 9/07; H01G 9/0029

(57) ABSTRACT

The dispersion disclosed herein is a dispersion used for manufacturing an electrolytic capacitor, including a conductive polymer, an insulating material, and a dispersion medium. The insulating material contains at least one kind of material selected from the group consisting of insulating fibers and insulating particles.

### TECHNICAL FIELD

The present disclosure relates to a dispersion used for manufacturing an electrolytic capacitor, a method for manufacturing an electrolytic capacitor, and an electrolytic capacitor.

### BACKGROUND ART

An electrolytic capacitor that includes a wound body including an anode foil, a separator, and a cathode foil is known. An example of such an electrolytic capacitor includes a conductive polymer layer disposed inside the wound body. The conductive polymer layer is formed by impregnating the wound body with a dispersion liquid that contains particles of a conductive polymer, for example. Various proposals have been made for an electrolytic capacitor including a conductive polymer layer and a method for manufacturing the same.
PTL 1 (Japanese Patent No. 5062738) discloses “a conductive composition comprising a conductive polymer synthesized by oxidatively polymerizing pyrrole or a derivative thereof using an organic sulfonate and a persulfate, the organic sulfonate being constituted of a polystyrene sulfonate having a number average molecular weight of 10000 to 300000 and an aromatic sulfonate, an aromatic sulfonic acid portion of the aromatic sulfonate being 20% by mass to 50% by mass relative to a polystyrene sulfonic acid portion of the polystyrene sulfonate, wherein a pH of a dispersion liquid having a total concentration of 1% by mass of the conductive polymer and a component derived from an added pH improver is 1.5 to 4.5”.
PTL 2 (Japanese Laid-Open Patent Publication No. 2007-27767) discloses a method comprising the steps of: applying a) a dispersion containing at least b) particles of a predetermined conductive polymer, c) a binder, and d) a dispersant to a capacitor body containing at least a solid electrolyte; and removing at least a portion of d) the dispersant and/or curing the c) binder to form a conductive polymer outer layer.
PTL 3 (Japanese Patent No. 6951159) discloses “a capacitor comprising: an anode made of a valve metal; a dielectric layer made of an oxide of the valve metal; a cathode made of a conductive material provided opposite the anode on the dielectric layer; and a solid electrolyte layer formed between the dielectric layer and the cathode, the solid electrolyte layer having a conductive complex containing a x-conjugated conductive polymer and a polyanion, and a binder, wherein the binder contains a styrene-butadiene rubber”.

### CITATION LIST

### Patent Literature

PTL 1: Japanese Patent No. 5062738
PTL 2: Japanese Laid-Open Patent Publication No. 2007-27767
PTL 3: Japanese Patent No. 6951159

### SUMMARY OF INVENTION

### Technical Problem

When a conductive polymer layer is formed using a conventional dispersion containing a conductive polymer, the performance of the capacitor may be degraded if the conductive polymer adheres to a defective portion of the dielectric layer on the surface of the anode foil, or if the anode and cathode portions are too close to each other. For example, if the conductive polymer adheres to a defective portion of the dielectric layer on the surface of the anode foil, the withstand voltage may decrease or the leakage current may increase.

In such a situation, an object of the present disclosure is to provide an electrolytic capacitor capable of stably achieving high performance, a dispersion liquid for manufacturing the same, and a method for manufacturing the same.

### Solution to Problem

A first aspect of the present disclosure relates to a dispersion used for manufacturing an electrolytic capacitor. The dispersion contains a conductive polymer, an insulating material, and a dispersion medium, and the insulating material contains at least one kind of material selected from the group consisting of insulating fibers and insulating particles.

Another aspect of the present disclosure relates to a method for manufacturing an electrolytic capacitor. The manufacturing method is a method for manufacturing an electrolytic capacitor including an anode portion having a dielectric layer formed on the surface thereof, and a cathode portion, the manufacturing method including a step (X) of disposing a conductive polymer and an insulating material between the dielectric layer and the cathode portion, the insulating material containing at least one kind of material selected from the group consisting of insulating fibers and insulating particles.

Another aspect of the present disclosure relates to an electrolytic capacitor. The electrolytic capacitor includes an anode portion having a dielectric layer formed on a surface thereof, a cathode portion, and a conductive polymer and an insulating material disposed between the dielectric layer and the cathode portion, the insulating material containing at least one kind of material selected from the group consisting of insulating fibers and insulating particles.

### Advantageous Effects of Invention

According to the present disclosure, it is possible to obtain an electrolytic capacitor capable of stably achieving high performance.

While novel features of the present invention are set forth in the appended claims, both the configuration and content of the present invention, as well as other objects and features of the present invention, will be better understood from the following detailed description given with reference to the drawings.

### BRIEF DESCRIPTION OF DRAWINGS

FIG. 1 is a side view schematically showing an electrolytic capacitor according to an embodiment of the present disclosure.

FIG. 2 is an exploded perspective view schematically showing a capacitor element according to an embodiment of the present disclosure.

### DESCRIPTION OF EMBODIMENTS

The following describes an example embodiment of the present disclosure, but the present disclosure is not limited to the following example. In the following description, specific numerical values and materials are given as examples in some cases, but other numerical values and other materials may also be applied as long as the advantageous effects of the present disclosure can be achieved. In this specification, the expression “a numerical value A to a numerical value B” includes the numerical value A and the numerical value B, and can be read as “not less than the numerical value A and not greater than the numerical value B”. In the following description, if lower and upper limits of numerical values related to specific physical properties, conditions, etc. are illustrated, any of the illustrated lower limits and any of the illustrated upper limits can be combined as desired as long as the lower limit is not equal to or greater than the upper limit. In the following description, when examples of components are listed, only one of the listed examples may be used, or two or more of the listed examples may be used in combination, unless otherwise noted.

### (Dispersion Used for Manufacturing Electrolytic Capacitor)

The dispersion according to the present embodiment is used for manufacturing an electrolytic capacitor. Hereinafter, the dispersion according to the present embodiment may be referred to as a “dispersion (D1)”.

The dispersion (D1) contains a conductive polymer, an insulating material, and a dispersion medium. The insulating material includes at least one kind of material selected from the group consisting of insulating fibers and insulating particles. Hereinafter, the insulating material may be referred to as an “insulating material (I)”.

The dispersion (D1) contains the insulating material (I). Therefore, by forming a conductive polymer layer using the dispersion (D1), it is possible to prevent the conductive polymer from adhering to a defective portion of the dielectric layer on the surface of the anode foil and to prevent the anode portion and the cathode portion from coming too close to each other, thereby making it possible to prevent the withstand voltage of the electrolytic capacitor from decreasing and the leakage current from increasing. Therefore, by using the dispersion (D1), it is possible to obtain an electrolytic capacitor that is capable of stably achieving high performance. Examples of the components of the dispersion (D1) are described below.

### (Insulating Material (I))

As described above, the insulating material (I) contains at least one kind of material selected from the group consisting of insulating fibers and insulating particles. The insulating material (I) may be constituted of insulating fibers alone, insulating particles alone, or both of them. The insulating material (I) preferably contains insulating fibers in terms of dispersibility in the dispersion (D1).

The insulating fibers used as the insulating material (I) may include a fiber containing at least one kind of material selected from the group consisting of cellulose, rayon, aramid, polyester, polyimide, and nylon, or may be a fiber made of the at least one kind of material. By using these insulating fibers, the dispersibility in the dispersion (D1) can be increased, and a decrease in the withstand voltage of the electrolytic capacitor can be significantly suppressed. Alternatively, insulating fibers other than these fibers may be used.

The average diameter of the insulating fibers may be 0.1 μm or more, 1 μm or more, or 10 μm or more, and may be 100 μm or less, or 50 μm or less. The cross section of the insulating fibers may be substantially a perfect circle, or may have another shape (e.g., an ellipse). The diameter of fibers means the equivalent circle diameter. By setting the average diameter of the insulating fibers in the range of 1 μm to 50 μm (e.g., in the range of 10 μm to 50 μm), the advantageous effects of the present disclosure can be enhanced. The average fiber diameter is obtained by measuring the diameter (equivalent circle diameter) at any position of thirty randomly selected fibers and calculating the arithmetic mean of the thirty measured diameters. The equivalent circle diameter can be measured, for example, by analyzing an image of the cross section of each fiber.

The insulating fibers may have an average fiber length of 100 μm or more. The upper limit of the average fiber length is not particularly limited, and may be, for example, 5000 μm or less. The average fiber length is obtained by calculating the arithmetic mean of the lengths of thirty randomly selected fibers.

The insulating particles used as the insulating material (I) may include particles containing at least one kind of material selected from the group consisting of polyolefin, polyester, polytetrafluoroethylene, and ceramic (insulating ceramic) from the standpoint of suppressing a decrease in the withstand voltage of the electrolytic capacitor, or may be particles constituted of the at least one kind of material. Alternatively, insulating particles other than these particles may be used.

The average particle diameter of the insulating particles may be 0.1 μm or more, 10 μm or more, or 20 μm or more, and may be 100 μm or less, or 50 μm or less. In this specification, the average particle diameter is the median diameter (D50) at which the cumulative volume in the volume based particle size distribution is 50%. The median diameter is determined using a laser diffraction/scattering type particle size distribution analyzer.

The shape of the insulating particles is not particularly limited, and may be spherical (including oval spherical shape, etc.), scale-like, needle-like, or lattice-like. Alternatively, the shape of the insulating particles does not need to be particularly determined.

Insulating fibers and insulating particles are commercially available in a variety of materials and shapes. For the insulating material (I), commercially available insulating fibers and/or insulating particles may be used. Alternatively, insulating fibers and/or insulating particles manufactured by a known method may be used.

The content Ci (% by mass) of the insulating material (I) in the dispersion (D1) may be 0.1% by mass or more, or 1.0% by mass or more, and may be 5.0% by mass or less, or 3.0% by mass or less. By setting the content to 1.0% by mass or more, the advantageous effects of the present disclosure can be enhanced. By setting the content to 3.0% by mass or less, a decrease in the conductivity of the conductive polymer layer can be suppressed.

The ratio Ci/Cc of the content Ci (% by mass) to the content Cc (% by mass) of the conductive polymer in the dispersion (D1) may be 0.1 or more, or 0.5 or more, and may be 2.0 or less, or 1.0 or less. By setting the ratio Ci/Cc to 0.5 or more, the advantageous effects of the present disclosure can be enhanced. By setting the ratio Ci/Cc to 1.0 or less, a decrease in the conductivity of the conductive polymer layer can be suppressed.

### (Dispersion Medium)

The dispersion medium is a medium in which the conductive polymer is dispersed. The dispersion medium preferably contains water. The water content in the dispersion medium may be 50% by mass or more, 70% by mass or more, 90% by mass or more, or 95% by mass or more. The water content may be 100% by mass. That is to say, the dispersion medium may be water. The dispersion medium may contain an organic solvent other than water. Note that an additive (A) is not contained in the dispersion medium.

### (Conductive Polymer)

The conductive polymer is not particularly limited, and may be any conductive polymer that can be used in an electrolytic capacitor. The conductive polymer may be a known conductive polymer used as an electrolyte in an electrolytic capacitor.

Examples of the conductive polymer include polypyrrole, polythiophene, polyfuran, polyaniline, polyacetylene, and derivatives thereof. The derivatives include polymers based on the main backbones of polypyrrole, polythiophene, polyfuran, polyaniline, and polyacetylene. For example, polythiophene derivatives include poly(3,4-ethylenedioxythiophene), etc. These conductive polymers may be used alone or in combination of two or more kinds. The conductive polymer may also be a copolymer of two or more kinds of monomers. The weight average molecular weight of the conductive polymer is not particularly limited, and may be in the range of 1000 to 100000, for example. A preferred example of the conductive polymer is poly(3,4-ethylenedioxythiophene) (PEDOT).

The conductive polymer may be doped with a dopant. From the standpoint of suppressing de-doping from the conductive polymer, it is preferable to use a polymer dopant as the dopant. Examples of polymer dopants include polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, polyacrylic acid, etc. These dopants may be used alone or in combination of two or more kinds. At least some of these dopants may be added in the form of a salt. A preferred example of the dopant is polystyrene sulfonic acid (PSS). In one preferred example, the conductive polymer is poly(3,4-ethylenedioxythiophene) and the dopant is polystyrenesulfonic acid.

The dopant may be a dopant containing an acidic group or a polymerer dopant containing an acidic group. Examples of the acidic group include a sulfonic acid group, a carboxyl group, etc. The polymer dopant containing an acidic group is a polymer in which at least some constituent units contain an acidic group. Examples of such a polymer dopant include the polymer dopants described above.

The weight average molecular weight of the dopant is not particularly limited. From the standpoint of facilitating formation of a uniform conductive polymer layer, the weight average molecular weight of the dopant may be in the range of 1000 to 100000.

When the conductive polymer doped with the dopant is used, the pH of the dispersion (D1) is preferably less than 7.0 in order to suppress de-doping of the dopant, and may be 6.0 or less, or 5.0 or less. The pH of the dispersion (D1) may be 1.0 or more, 2.0 or more, or 3.0 or more.

The conductive polymer may be present in the state of particles in the dispersion (D1). The average particle diameter (D50) of the conductive polymer particles may be 10 μm or more, or 20 μm or more, and may be 100 μm or less.

The content of the conductive polymer in the dispersion (D1) may be 0.5% by mass or more, or 1.0% by mass or more, and may be 7.0% by mass or less, 5.0% by mass or less, or 3.0% by mass or less. The content may be in the range of 0.5% by mass to 7.0% by mass, or in the range of 1.0% by mass to 5.0% by mass. Within either of these ranges, the upper limit may be 3.0% by mass or 2.0% by mass. The content is preferably in the range of 1.0% by mass to 5.0% by mass (e.g., in the range of 1.0% by mass to 3.0% by mass) in terms of achieving excellent physical properties of the dispersion (D1), excellent stability of the physical properties over time, and a good balance between the ESR of the electrolytic capacitor and the cost.

The mass of the dopant contained in the dispersion (D1) is not particularly limited, and may be in the range of 0.1 times to 5 times (e.g., in the range of 0.5 times to 3 times) the mass of the conductive polymer contained in the dispersion (D1).

### (Additive)

The dispersion (D1) may further contain an additive containing a hydroxy group, and the dispersion medium may contain water. Hereinafter, the additive may be referred to as an “additive (A)”. The ratio Mh/Mt of the total formula weight Mh of the hydroxy groups contained in the additive (A) to the molecular weight Mt of the additive may be 0.001 or more. In the case of ethylene glycol (HO—CH₂—CH₂—OH), the molecular weight Mt is 62 and the total formula weight Mh of the two hydroxyl groups is 34. Therefore, Mh/Mt=34/62=0.55. When the molecular weight of the additive (A) is not constant, the weight average molecular weight is used as the molecular weight of the additive (A). The conductive polymer (e.g., conductive polymer particles) and the insulating material (I) tend to aggregate. The addition of the additive (A) can prevent them from aggregating. Therefore, by forming a conductive polymer layer using the dispersion (D1) containing the additive (A), a conductive polymer layer having high dispersibility of the insulating material (I) can be formed.

The ratio Mh/Mt may be 0.03 or more, or 0.07 or more, and may be 0.9 or less. By setting the ratio Mh/Mt to 0.03 or more, the advantageous effects of the additive (A) can be sufficiently obtained.

The molecular weight of the additive (A) is preferably 500 or less. By setting the molecular weight to 500 or less, the dispersibility in the dispersion (D1) can be increased. As a result, the additive (A) is more likely to adhere to a defective portion of the dielectric layer. The lower limit of the molecular weight is not particularly limited, and may be 44 or more, 80 or more, or 150 or more. The molecular weight may be 500 or less, 400 or less, 200 or less, or 120 or less.

The number of hydroxy groups contained in the additive (A) may be one or more or two or more, and may be six or less or three or less. From the standpoint of repairing the defective portion of the dielectric layer, the number of hydroxyl groups is preferably 3 or less.

Examples of the additive (A) include polyols. In this specification, a polyol means an organic compound that contains two or more hydroxy groups. Examples of the polyol include glycols, glycerins, and sugar alcohols. The polyol may be a hydrocarbon compound substituted with two or more hydroxyl groups (e.g., an aliphatic hydrocarbon substituted with two or more hydroxyl groups). The additive (A) is preferably a compound that is soluble in water. The additive (A) may be an organic compound containing three or fewer hydroxy groups (e.g., a lower alcohol with three or fewer hydroxy groups). The molecular weight of the organic compound may be 500 or less.

Examples of glycols include alkylene glycols (such as ethylene glycol and propylene glycol), diethylene glycol, triethylene glycol, polyalkylene glycols (e.g., polyethylene glycol), polyoxyethylene polyoxypropylene glycol (ethylene oxide-propylene oxide copolymers), etc. Examples of glycerins include glycerin, polyglycerin, etc. Examples of sugar alcohols include mannitol, xylitol, sorbitol, erythritol, pentaerythritol, etc.

The additive (A) may be at least one kind of material selected from the group consisting of glycols, glycerins, and sugar alcohols. For example, the additive (A) may be at least one selected from the group consisting of ethylene glycol, polyethylene glycol, diethylene glycol, triethylene glycol, glycerin, polyglycerin, erythritol, xylitol, sorbitol, and mannitol. A preferred example of the additive (A) is ethylene glycol.

The ratio Ca/Ci of the content Ca (% by mass) of the additive (A) in the dispersion (D1) to the content Ci (% by mass) of the insulating material (I) in the dispersion (D1) may be 0.1 or more, or 1.0 or more, and may be 8.0 or less, or 4.0 or less.

### (Method for Manufacturing Dispersion (D1))

The method for manufacturing the dispersion (D1) is not particularly limited. For example, the dispersion (D1) can be manufactured by dispersing and dissolving the components of the dispersion (D1) in a dispersion medium. Specifically, the components of the dispersion (D1) are added to the dispersion medium and stirred to manufacture the dispersion (D1).

### (Method for Manufacturing Electrolytic Capacitor)

The manufacturing method according to the present embodiment is a method for manufacturing an electrolytic capacitor including an anode portion having a dielectric layer formed on the surface thereof, and a cathode portion. This manufacturing method can be used to manufacture both a stacked electrolytic capacitor and a sintered electrolytic capacitor. The capacitor element of a stacked electrolytic capacitor includes a stacked body including at least one sheet-shaped anode portion, at least one sheet-shaped cathode portion, and at least one separator. The stacked body may be formed by stacking them in one direction. In this case, the electrolytic capacitor may include a plurality of capacitor elements. Alternatively, the stacked body may be a wound body obtained by winding a sheet-shaped anode portion, a sheet-shaped cathode portion, and a separator. For the anode portion of a sintered electrolytic capacitor, a sintered body of a metal containing a valve metal or a metal compound containing a valve metal can be used. Examples of the components of the electrolytic capacitor will be described later.

This manufacturing method may be carried out using the dispersion (D1) described above. The matters described about the dispersion (D1) are applicable to this manufacturing method, and therefore, redundant descriptions thereof may be omitted.

This manufacturing method includes a step (X) of disposing a conductive polymer and an insulating material between a dielectric layer formed on the surface of the anode portion and the cathode portion. The insulating material is the insulating material (I) described above. As described above, the insulating material (I) contains at least one kind of material selected from the group consisting of insulating fibers and insulating particles. By the step (X), the conductive polymer can be prevented from adhering to a defective portion of the dielectric layer on the surface of the anode foil, and the anode portion and the cathode portion can be prevented from coming too close to each other. Therefore, with this manufacturing method, it is possible to manufacture an electrolytic capacitor capable of stably achieving high performance.

By the step (X), a layer containing a conductive polymer can be formed between the dielectric layer and the cathode portion. Hereinafter, the layer containing conductive polymer may be referred to as a “conductive polymer layer”.

The step (X) may be carried out using a first dispersion containing a conductive polymer, an insulating material (I), and a dispersion medium. The first dispersion is the dispersion (D1) described above. For example, the step (X) may include a step of applying the dispersion (D1) to at least one member (an object to which the dispersion (D1) is to be applied) selected from the group consisting of a dielectric layer formed on the surface of an anode portion, and a cathode portion, and drying the dispersion (D1). Alternatively, the step (X) may include a step of applying the dispersion (D1) to at least one member (an object to which the dispersion (D1) is to be applied) selected from the group consisting of a dielectric layer formed on the surface of an anode portion, a cathode portion, and a separator, and drying the dispersion (D1).

The method for disposing the conductive polymer and the insulating material (I) in the step (X) is not particularly limited. For example, the dispersion (D1) may be applied to an object to which the dispersion (D1) is to be applied and dried. The application method is not particularly limited, and any known method may be used. The application method may be a method using a coater or a method of spraying the dispersion (D1). Alternatively, the object to which the dispersion (D1) is to be applied may be immersed in the dispersion (D1). The dispersion (D1) may be dried by removing at least a portion of the dispersion medium by heating. For example, heating may be performed at a temperature of 100° C. or higher (e.g., 120° C. or higher, or 140° C. or higher). There is no upper limit to the heating temperature, but the temperature is such that it does not affect components such as the conductive polymer, for example, at 160° C. or lower. There is no limitation on the heating time, and the heating time may be determined taking into consideration the amount of evaporation of the dispersion medium, etc. Drying may be carried out under reduced pressure. These application and drying methods can also be applied to the application and drying methods described below.

The step (X) may include a step (a) of applying the dispersion (D1) to the dielectric layer formed on the surface of the anode portion and drying the dispersion (D1) to adhere the conductive polymer and the insulating material (I) to the surface of the dielectric layer. The step (a) makes it easier to dispose the insulating material (I) in the defective portion of the dielectric layer. When a stacked electrolytic capacitor is to be manufactured, the step (a) may be carried out by applying the dispersion (D1) to the anode portion before forming the stacked body and drying the dispersion (D1). Alternatively, the step (a) may be carried out by forming a stacked body, impregnating the stacked body with the dispersion (D1), and thereafter drying the dispersion (D1). When a sintered electrolytic capacitor is to be manufactured, the dispersion (D1) may be applied to (e.g., impregnated into) an anode portion (sintered body) on which a dielectric layer is formed, and thereafter the dispersion (D1) may be dried.

The electrolytic capacitor may further include a separator disposed between the dielectric layer formed on the surface of the anode portion, and the cathode portion. In this case, the step (X) may include a step (X1) and a step (X2) in this order. The step (X1) is a step of applying the dispersion (D1) to at least one element selected from the group consisting of the dielectric layer, the cathode portion, and the separator, and drying the dispersion (D1), thereby causing the conductive polymer and the insulating material to adhere to the at least one element. The step (X2) is a step of stacking the anode portion, the separator, and the cathode portion to form a stacked body. These steps are preferably used for manufacturing a stacked electrolytic capacitor. In the step (X1), it is preferable to apply the dispersion (D1) to at least the dielectric layer and dry the dispersion (D1). This allows the insulating material (I) to be disposed in the defective portion of the dielectric layer, thereby preventing the performance of the capacitor from degrading due to the defect in the dielectric layer.

The manufacturing method according to the present embodiment may further include, after the step (X), a step (Z) of impregnating the stacked body with a liquid component (hereinafter may also referred to as a “liquid component (L)”). Examples of the liquid component (L) will be described later.

The manufacturing method according to the present embodiment may include a step (Y1) and a step (Y2) after the step (X) and before the step (Z). Hereinafter, the step (Y1) and the step (Y2) may be collectively referred to as “the steps (Y)”. The step (Y1) is a step of impregnating the stacked body with a treatment liquid containing water and an organic compound that contains two or more hydroxy groups. Hereinafter, the organic compound and the treatment liquid may be referred to as an “organic compound (C)” and a “treatment liquid(S)”. The step (Y2) is a step of evaporating at least a portion of the water in the treatment liquid(S).

By carrying out the step (Y), it is possible to dispose the organic compound (C) in the conductive polymer layer. This makes it easier to impregnate the stacked body with the liquid component (L) in the step (Z).

In the step (Y1), there is no limitation on the method for impregnating the stacked body with the treatment liquid(S). For example, the stacked body may be immersed in the treatment liquid(S). In the step (Y2), there is no limitation on the step of evaporating at least a portion of the water in the treatment liquid(S). The step (Y2) may be carried out under the conditions illustrated for drying the dispersion (D1).

Examples of the organic compound (C) include polyols. Examples of polyols include the compounds given as examples of the polyols for the additive (A).

The water content in the treatment liquid(S) may be 40% by mass or more, 60% by mass or more, 80% by mass or more, 90% by mass or more, or 95% by mass or more. The content may be 99% by mass or less, 95% by mass or less, 90% by mass or less, or 80% by mass or less.

The content of the organic compound (C) in the treatment liquid(S) may be 1.0% by mass or more, 5.0% by mass or more, 10% by mass or more, or 20% by mass or more. The content may be 60% by mass or less, 40% by mass or less, 20% by mass or less, or 10% by mass or less.

The step (X) may include a step (b1) and a step (b2) in this order. The step (b1) is a step of applying a second dispersion (D2) containing the insulating material (I) to the dielectric layer formed on the surface of the anode portion, and drying the second dispersion (D2), thereby causing the insulating material (I) to adhere to the surface of the dielectric layer. The step (b2) is a step of applying a third dispersion (D3) containing the conductive polymer to the dielectric layer to which the insulating material (I) has adhered, and drying the third dispersion (D3), thereby causing the conductive polymer to adhere to the dielectric layer to which the insulating material (I) has adhered. The dispersion (D2) is the dispersion illustrated as the dispersion (D1) from which the conductive polymer is removed. The dispersion (D3) is a dispersion containing a conductive polymer. The dispersion (D3) may be the dispersion illustrated as the dispersion (D1), or the dispersion illustrated as the dispersion (D1) from which the insulating material (I) is removed.

The manufacturing method according to the present embodiment may include a step of forming a conductive polymer layer using a fourth dispersion (D4). The dispersion (D4) is the dispersion illustrated as the dispersion (D1) from which the insulating material (I) is removed. For example, after forming a first conductive polymer layer using the dispersion (D1), a second conductive polymer layer may be formed on the first conductive polymer layer, using the dispersion (D4). In the above steps, the step of applying and drying the dispersions (the dispersions (D1) to (D4)) may be carried out only once or may be repeated a plurality of times.

Except for the above steps, there are no limitation on the steps for manufacturing the electrolytic capacitor, and a known manufacturing method may be applied. An example of a method for manufacturing a stacked electrolytic capacitor will be described below.

First, an anode foil (anode portion) having a dielectric layer formed on the surface thereof, a cathode foil (cathode portion), and a separator are prepared. Then, a stacked body is formed using these members. The separator is disposed between the anode foil and the cathode foil. A lead is connected to each of the anode foil and the cathode foil as required.

At least one anode foil, at least one cathode foil, and at least one separator may be stacked in one direction to form a stacked body. Alternatively, an anode foil, a cathode foil, and a separator may be wound together to form a wound body (stacked body). In the wound body, the anode foil, the cathode foil, and the separator are stacked in the radial direction. Therefore, the wound body is also a stacked body.

The step (X) may be carried out on the member before the stacked body is formed. For example, the step (X1) and the step (X2) may be carried out. Alternatively, the step (X) may be carried out after the stacked body is formed. In this case, the step (X) can be carried out by impregnating the stacked body with the dispersion (D1) and thereafter drying the stacked body. By the step (X), a conductive polymer layer can be formed between the dielectric layer and the cathode foil (cathode portion).

The stacked body (capacitor element) that has undergone the step (X) is enclosed in an exterior body. In this manner, a stacked electrolytic capacitor can be manufactured. As described above, the step (Z) may be carried out after the step (X). Alternatively, the step (Y) and the step (Z) may be carried out after the step (X).

The impregnation of the stacked body with a liquid (such as the dispersion (D1), the dispersion (D2), the dispersion (D3), the dispersion (D4), the treatment liquid(S), and the liquid component (L)) may be carried out by immersing the stacked body in the liquid. Subsequent drying may be accomplished by heating the stacked body. Heating may be performed under reduced pressure.

An example of a method for manufacturing a sintered electrolytic capacitor will be described below. First, a sintered body (anode portion) having a dielectric layer formed on the surface thereof is prepared. An anode lead is connected to the sintered body as required.

Next, the dispersion (D1) is applied to the sintered body on which the dielectric layer is formed and dried to adhere the conductive polymer and the insulating material to the surface of the dielectric layer (step (a)). By this step, a conductive polymer layer is formed on the surface of the dielectric layer. There is no limitation on the method for applying the dispersion (D1), and the dispersion (D1) may be applied by a general method, or by immersing the sintered body in the dispersion (D1). Subsequent drying can be accomplished by the method described above.

Next, a cathode portion is formed on the conductive polymer layer. The method for forming the cathode portion is not particularly limited, and the cathode portion may be formed by a known method. In this manner, a capacitor element is formed. Note that an anode lead terminal is electrically connected to the anode portion, and the cathode lead terminal is electrically connected to the cathode portion, as required. Furthermore, the capacitor element is sealed with an exterior body (e.g., sealing resin) as required. In this manner, a sintered electrolytic capacitor is manufactured.

An example of the configuration and components of an electrolytic capacitor manufactured by the manufacturing method according to the present embodiment will be described below. Note that the configuration and components of the electrolytic capacitor are not limited to the following examples. As components other than the components characteristic of the present disclosure, known components of an electrolytic capacitor may be used.

The electrolytic capacitor includes a capacitor element. The capacitor element includes an anode portion and a cathode portion, and a dielectric layer is formed on the surface of the anode portion. The capacitor element of a stacked electrolytic capacitor further includes a separator disposed between the anode portion and the cathode portion.

### (Anode Portion)

The anode portion includes an anode body. The anode body may be a porous sintered body or a metal foil having a porous surface. The thickness of the metal foil is not particularly limited and may be in the range of 15 μm to 300 μm. The dielectric layer is formed on at least a portion of the surface of the anode body.

As the material of the anode body, a valve metal, an alloy containing a valve metal, or a compound of a valve metal can be used. Examples of the valve metal include titanium (Ti), tantalum (Ta), niobium (Nb), aluminum (Al), etc. The anode body may be a sintered body formed by sintering particles (e.g., particles of a valve metal) used as the material. Alternatively, the anode body may be formed by etching the surface of a metal foil (e.g., aluminum foil) used as the material. The dielectric layer formed on the surface of the anode body may be formed by subjecting the surface of the anode body to a chemical conversion treatment. There is no limitation on the chemical conversion treatment method, and a known chemical conversion treatment method may be applied.

When the anode body is a sintered body, the anode portion may include an anode wire. The anode wire may be a wire made of metal. Examples of the material of the anode wire include the valve metal mentioned above and copper. A portion of the anode wire is embedded in the anode body, and the remaining portion protrudes from an end surface of the anode body.

### (Cathode Portion)

The cathode portion may include an electrolyte layer and a cathode foil. Alternatively, the cathode portion may include an electrolyte layer and a cathode extraction layer.

The cathode foil is not particularly limited as long as it functions as a cathode. Examples of the cathode foil include metal foils (e.g., an aluminum foil). The type of metal is not particularly limited, and may be a valve metal or an alloy containing a valve metal. The thickness of the cathode foil is not particularly limited and may be in the range of 15 μm to 300 μm. The surface of the cathode foil may be roughened or subjected to a chemical conversion treatment as required.

The cathode foil may include a conductive coating layer. When the metal foil contains a valve metal, the coating layer may contain carbon and at least one kind of metal having a lower ionization tendency than the valve metal. This makes it easier to improve the acid resistance of the metal foil. When the metal foil contains aluminum, the coating layer may contain at least one selected from the group consisting of carbon, nickel, titanium, tantalum, and zirconium. In particular, the coating layer may contain nickel and/or titanium because of their low cost and resistance.

The cathode extraction layer is a conductive layer and is disposed so as to cover at least a portion of the electrolyte layer. The cathode extraction layer may include a carbon layer formed on the electrolyte layer, and a metal paste layer formed on the carbon layer. The carbon layer may be formed of a conductive carbon material, such as graphite, and a resin. The metal paste layer may be formed of metal particles (e.g., silver particles) and a resin, and may be formed, for example, of a known silver paste.

### (Electrolyte Layer)

The electrolyte layer is disposed between the dielectric layer formed on the surface of the anode portion, and the cathode portion. The electrolyte layer contains a conductive polymer (e.g., a conductive polymer layer). The electrolyte layer may contain a conductive polymer and a liquid component (L) (e.g., an electrolyte solution). The conductive polymer has been described above, and therefore, redundant descriptions thereof may be omitted.

### (Liquid Component (L))

Examples of the liquid component (L) include a non-aqueous solvent and an electrolyte solution. As the electrolyte solution, it is possible to use a non-aqueous electrolyte solution containing a non-aqueous solvent and a solute dissolved in the non-aqueous solvent. The liquid component (L) may contain a small amount of water. In this specification, the liquid component (L) may be a component that is liquid at room temperature (25° C.) or a component that is liquid at a temperature at which the electrolytic capacitor is used.

The non-aqueous solvent may be an organic solvent or an ionic liquid. Examples of the non-aqueous solvent include polyhydric alcohols such as ethylene glycol and propylene glycol, cyclic sulfones such as sulfolane (SL), lactones such as γ-butyrolactone (γBL), amides such as N-methylacetamide, N,N-dimethylformamide, and N-methyl-2-pyrrolidone, esters such as methyl acetate, carbonate compounds such as propylene carbonate, ethers such as 1,4-dioxane, ketones such as methyl ethyl ketone, and formaldehyde.

It is also possible to use a polymer-based solvent as the non-aqueous solvent. Examples of the polymer-based solvent include polyalkylene glycol, derivatives of polyalkylene glycol, and compounds in which at least one hydroxyl group of a polyhydric alcohol is substituted with polyalkylene glycol (including derivatives thereof). Specific examples of the polymer-based solvent include polyethylene glycol (PEG), polyethylene glycol glyceryl ether, polyethylene glycol diglyceryl ether, polyethylene glycol sorbitol ether, polypropylene glycol, polypropylene glycol glyceryl ether, polypropylene glycol diglyceryl ether, polypropylene glycol sorbitol ether, and polybutylene glycol. Examples of the polymer-based solvent further include ethylene glycol-propylene glycol copolymer, ethylene glycol-butylene glycol copolymer, and propylene glycol-butylene glycol copolymer. A non-aqueous solvent may be used alone, or a mixture of two or more non-aqueous solvents may be used.

The liquid component (L) may contain an acid component and a base component. Examples of the acid component include maleic acid, phthalic acid, benzoic acid, pyromellitic acid, and resorcylic acid. Examples of the base component include 1,8-diazabicyclo[5,4,0]undecene-7, 1,5-diazabicyclo[4,3,0] nonene-5, 1,2-dimethylimidazolinium, 1,2,4-trimethylimidazoline, 1-methyl-2-ethyl-imidazoline, 1,4-dimethyl-2-ethylimidazoline, 1-methyl-2-heptylimidazoline, 1-methyl-2-(3′heptyl)imidazoline, 1-methyl-2-dodecylimidazoline, 1,2-dimethyl-1,4,5,6-tetrahydropyrimidine, 1-methylimidazole, 1-methylbenzoimidazole, etc.

The non-aqueous electrolyte solution contains a non-aqueous solvent and a solute (e.g., an organic salt) dissolved therein. Examples of the non-aqueous solvent constituting the non-aqueous electrolyte solution include the examples of the non-aqueous solvent mentioned above. Examples of the solute include an inorganic salt and an organic salt. An organic salt is a salt in which at least one of the anion and the cation contains an organic substance. Examples of the organic salt include trimethylamine maleate, triethylamine borodisalicylate, ethyldimethylamine phthalate, mono-1,2,3,4-tetramethylimidazolinium phthalate, mono-1,3-dimethyl-2-ethylimidazolinium phthalate, etc.

In order to suppress de-doping of the dopant, the pH of the liquid component (L) may be less than 7.0, or 5.0 or less, and may be 1.0 or more, or 2.0 or more. The pH may be 1.0 or more and less than 7.0 (e.g., within the range of 2.0 to 5.0).

### (Separator)

A porous sheet can be used as the separator. Examples of the porous sheet include woven fabric, nonwoven fabric, and a microporous membrane. The thickness of the separator is not particularly limited and may be within the range of 10 to 300 μm. Examples of a material for the separator include cellulose, polyethylene terephthalate, polybutylene terephthalate, polyphenylene sulfide, vinylon, nylon, aromatic polyamide, polyimide, polyamide imide, polyetherimide, rayon, glass, etc.

### (Others)

The electrolytic capacitor may include other components (a lead, an exterior body, etc.) as required. The lead and the exterior body are not particularly limited, and known lead and exterior body may be used.

### (Electrolytic Capacitor)

Hereinafter, the electrolytic capacitor according to the present embodiment may be referred to as an “electrolytic capacitor (E)”. The electrolytic capacitor (E) can be manufactured by the manufacturing method described above. The matters described about the manufacturing method described above can also be applied to the electrolytic capacitor (E), and therefore, redundant descriptions thereof may be omitted. In addition, the matters described about the electrolytic capacitor (E) may also be applied to the manufacturing method described above. Note that the electrolytic capacitor (E) may be manufactured by a manufacturing method other than the manufacturing method described above.

The electrolytic capacitor (E) includes the anode portion having the dielectric layer formed on the surface thereof, the cathode portion, and the conductive polymer and the insulating material (I) disposed between the dielectric layer and the cathode portion. The insulating material (I) contains at least one kind of material selected from the group consisting of insulating fibers and insulating particles.

The electrolytic capacitor (E) includes the conductive polymer and the insulating material (I) disposed between the dielectric layer and the cathode portion. Therefore, it is possible to prevent the anode portion and the cathode portion from coming too close to each other. In addition, by disposing the insulating material (I) in the vicinity of the dielectric layer, it is possible to prevent the conductive polymer from adhering to the defective portion of the dielectric layer on the surface of the anode foil. This makes it possible to prevent the withstand voltage from decreasing and the leakage current from increasing, for example.

The electrolytic capacitor (E) may further include an additive (A) disposed between the dielectric layer and the cathode portion. As described above, the additive (A) contains hydroxy groups, and the ratio Mh/Mt is 0.03 or more, where Mh is the total formula weight of the hydroxy groups contained in the additive (A) and Mt is the molecular weight of the additive.

In the electrolytic capacitor (E), at least a portion of the insulating material (I) may adhere to the dielectric layer.

The electrolytic capacitor (E) may include a stacked body formed of an anode portion, a cathode portion, and a separator disposed between a dielectric layer and the cathode portion. In this case, at least a portion of the insulating material may adhere to at least one element selected from the group consisting of the dielectric layer, the cathode portion, and the separator. The stacked body may be impregnated with a liquid component (L).

An organic compound (C) containing two or more hydroxy groups may be disposed between the dielectric layer and the cathode portion.

The ratio of the content of the conductive polymer to the content of the insulating material (I) between the dielectric layer and the cathode portion may be within the range illustrated for the ratio Ci/Cc of the content Ci to the content Cc in the dispersion (D1). The ratio of the content of the additive A to the content of the insulating material (I) between the dielectric layer and the cathode portion may be within the range illustrated for the ratio Ca/Ci of the content Ca to the content Ci in the dispersion (D1).

An example of the electrolytic capacitor (E) will be specifically described below with reference to the drawings. The components described above can be applied to the components of the example described below. In addition, the components of the example described below can be modified based on the above description. In addition, the matters described below may be applied to the above embodiment. In addition, in the example described below, components that are not essential to the electrolytic capacitor according to the present disclosure may be omitted.

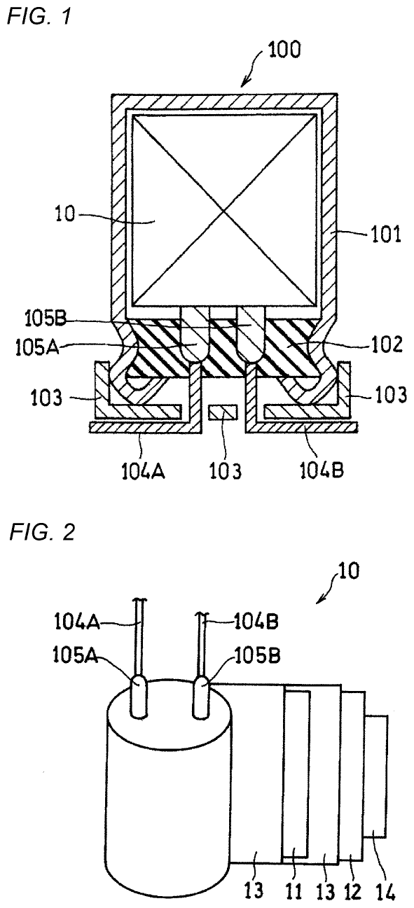

FIG. 1 is a cross-sectional view schematically showing an example of an electrolytic capacitor 100 according to the present embodiment. FIG. 2 is a schematic diagram in which a portion of a capacitor element 10 included in the electrolytic capacitor 100 is spread. The electrolytic capacitor 100 is a stacked capacitor including a wound body (stacked body).

The electrolytic capacitor 100 includes the capacitor element 10, a bottomed case 101 in which the capacitor element 10 is housed, a sealing member 102 sealing an opening of the bottomed case 101, a base plate 103 covering the sealing member 102, lead wires 104A and 104B drawn out from the sealing member 102 and passing through the base plate 103, and lead tabs 105A and 105B connecting the lead wires and electrodes of the capacitor element 10. The vicinity of an open end of the bottomed case 101 is pressed inward through drawing, and the open end is curled so as to be swaged on the sealing member 102.

The capacitor element 10 is a wound body like that shown in FIG. 2, for example. The wound body is formed by winding the anode foil 11, the cathode foil 12, and the separator 13. A dielectric layer (not shown) is formed on the surface of the anode foil 11. The capacitor element 10 includes a conductive polymer layer (not shown) disposed between the anode foil 11 (more specifically, the dielectric layer on the surface of the anode foil 11) and the cathode foil 12. The conductive polymer layer contains an insulating material (I). The electrolytic capacitor 100 may contain a liquid component (L) (e.g., an electrolyte solution) impregnated into the capacitor element 10.

The anode foil 11 and the cathode foil 12 are wound with the separator 13 disposed therebetween. The outermost turn of the wound body is fixed with a winding end tape 14. Note that FIG. 2 shows a state in which a portion of the wound body is spread before the outermost turn of the wound body is fixed.

The electrolytic capacitor only needs to include at least one capacitor element, and may include a plurality of capacitor elements. The number of capacitor elements included in the electrolytic capacitor can be determined depending on the application.

### (Additional Notes)

The above description of the embodiment discloses the following techniques.

### (Technique 1)

A dispersion used for manufacturing an electrolytic capacitor, including:
a conductive polymer; an insulating material; and a dispersion medium,
wherein the insulating material contains at least one kind of material selected from the group consisting of insulating fibers and insulating particles.

### (Technique 2)

The dispersion according to Technique 1, further including:
an additive containing hydroxy groups,
wherein the dispersion medium contains water, and
a ratio Mh/Mt is 0.03 or more, where Mh is a total formula weight of the hydroxy groups contained in the additive and Mt is a molecular weight of the additive.

### (Technique 3)

The dispersion according to Technique 1 or 2,
wherein the insulating fibers include a fiber containing at least one kind of material selected from the group consisting of cellulose, rayon, aramid, polyester, polyimide, and nylon.

### (Technique 4)

The dispersion according to any one of Techniques 1 to 3,
wherein the insulating particles include particles containing at least one kind of material selected from the group consisting of polyolefin, polyester, polytetrafluoroethylene, and ceramic.

### (Technique 5)

A manufacturing method for manufacturing an electrolytic capacitor including an anode portion having a dielectric layer formed on a surface thereof, and a cathode portion, the manufacturing method including:
a step (X) of disposing a conductive polymer and an insulating material between the dielectric layer and the cathode portion,
wherein the insulating material contains at least one kind of material selected from the group consisting of insulating fibers and insulating particles.

### (Technique 6)

The manufacturing method according to Technique 5,
wherein the step (X) includes:
a step (a) of applying a first dispersion containing the conductive polymer, the insulating material, and a dispersion medium to the dielectric layer and drying the first dispersion, thereby causing the conductive polymer and the insulating material to adhere to a surface of the dielectric layer.

### (Technique 7)

The manufacturing method according to Technique 5,
wherein the electrolytic capacitor further includes a separator disposed between the dielectric layer and the cathode portion, and
the step (X) includes:
   a step (X1) of applying a first dispersion containing the conductive polymer, the insulating material, and a dispersion medium to at least one element selected from the group consisting of the dielectric layer, the cathode portion, and the separator, and drying the first dispersion, thereby causing the conductive polymer and the insulating material to adhere to the at least one element; and
   a step (X2) of stacking the anode portion, the separator, and the cathode portion to form a stacked body, the step (X1) and the step (X2) being carried out in the stated order.

### (Technique 8)

The manufacturing method according to Technique 7,
a step (Z) of impregnating the stacked body with a liquid component after the step (X).

### (Technique 9)

The manufacturing method according to Technique 8, further including:
after the step (X) and before the step (Z),
a step (Y1) of impregnating the stacked body with a treatment liquid containing water and an organic compound with two or more hydroxyl groups; and
a step (Y2) of evaporating at least a portion of the water in the treatment liquid.

### (Technique 10)

The manufacturing method according to Technique 5,
wherein the step (X) includes:
   a step (b1) of applying a second dispersion containing the insulating material to the dielectric layer and drying the second dispersion, thereby causing the insulating material to adhere to a surface of the dielectric layer; and
   a step (b2) of applying a third dispersion containing the conductive polymer to the dielectric layer to which the insulating material has adhered, and drying the third dispersion, thereby causing the conductive polymer to adhere to the dielectric layer to which the insulating material has adhered, the step (b1) and the step (b2) being carried out in the stated order.

### (Technique 11)

An electrolytic capacitor including:
an anode portion having a dielectric layer formed on a surface thereof;
a cathode portion; and
a conductive polymer and an insulating material disposed between the dielectric layer and the cathode portion,
wherein the insulating material contains at least one kind of material selected from the group consisting of insulating fibers and insulating particles.

### (Technique 12)

The electrolytic capacitor according to Technique 11, further including:
an additive disposed between the dielectric layer and the cathode portion,
wherein the additive contains hydroxy groups, and
a ratio Mh/Mt is 0.03 or more, where Mh is a total formula weight of the hydroxy groups contained in the additive and Mt is a molecular weight of the additive.

### (Technique 13)

The electrolytic capacitor according to Technique 11 or 12,
wherein at least a portion of the insulating material adheres to the dielectric layer.

### (Technique 14)

The electrolytic capacitor according to any one of Techniques 11 to 13, including:
a stacked body formed of the anode portion, the cathode portion, and the separator disposed between the dielectric layer and the cathode portion,
wherein at least a portion of the insulating material adheres to at least one element selected from the group consisting of the dielectric layer, the cathode portion, and the separator.

### (Technique 15)

The electrolytic capacitor according to Technique 14,
wherein the stacked body is impregnated with a liquid component.

### EXAMPLES

The following describes the present disclosure more specifically based on examples, but the present disclosure is not limited to the examples.

### Experimental Example 1

In Experimental Example 1, a plurality of electrolytic capacitors were produced and evaluated by the following methods.

### (Capacitor A1)

An electrolytic capacitor (capacitor A1) was produced using the following method.

### (a) Preparation of Constituent Members

Surfaces of an aluminum foil (thickness: 100 μm) were roughened by performing etching on the aluminum foil. Dielectric layers were formed on the roughened surfaces of the aluminum foil by performing chemical conversion treatment. Thus, an anode foil having the dielectric layers on both surfaces thereof was obtained. Surfaces of an aluminum foil (thickness: 50 μm) were roughened by performing etching on the aluminum foil to obtain a cathode foil.

Nonwoven fabric (thickness: 50 μm) was prepared as a separator. The nonwoven fabric was constituted of 50% by mass of synthetic fibers (25% by mass of polyester fiber and 25% by mass of aramid fiber) and 50% by mass of cellulose, and contained polyacrylamide as a paper strength enhancing agent. The density of the nonwoven fabric was 0.35 g/cm³.

### (b) Preparation of Dispersion (d1)

A dispersion liquid (commercially available product) in which particles of poly(3,4-ethylenedioxythiophene) (PEDOT) doped with polystyrene sulfonic acid (PSS) were dispersed in water was prepared. A mixture of the insulating fiber of cellulose (insulating material (I)) and the additive (A) were added to this dispersion liquid to obtain a dispersion (d1). In the dispersion (d1), the content of the insulating fiber was set to 0.2% by mass, and the content of the additive (A) was set to 5.0% by mass. The content of the PEDOT in the dispersion (d1) was set to 2.0% by mass. Ethylene glycol was used as the additive (A).

### (c) Formation of Conductive Polymer Layer

The dispersion (d1) was applied to one surface of the anode foil (a surface of a dielectric layer) with use of a gravure coater. Thereafter, drying was performed to form a conductive polymer layer on the one surface of the anode foil (the surface of the dielectric layer). The drying was performed by heating the anode foil, to which the dispersion (d1) had been applied, at 125° C. for 5 minutes. Next, a conductive polymer layer was formed on another surface of the anode foil (a surface of a dielectric layer) using the same method.

Conductive polymer layers were formed on both surfaces of the cathode foil using the same method as that used to form the conductive polymer layers on both surfaces of the anode foil. Also, conductive polymer layers were formed on the separator by applying the dispersion (d1) to the separator and then performing drying using the same method as that used to form the conductive polymer layers on both surfaces of the anode foil.

### (d) Production of Capacitor Element

The anode foil, the cathode foil, and the separator were each cut into a predetermined size. An anode lead tab and a cathode lead tab were connected to the anode foil and the cathode foil. Next, the anode foil and the cathode foil were wound with the separator disposed therebetween. An anode lead wire and a cathode lead wire were respectively connected to end portions of the lead tabs protruding from the wound body. Chemical conversion treatment was performed again on the obtained wound body, and the dielectric layer was formed on an end surface of the anode foil. An end portion of an outer surface of the wound body was fixed with a winding end tape to obtain a capacitor element.

(e) Impregnation with Liquid Component

An electrolyte solution (liquid component (L)) was prepared by dissolving o-phthalic acid and triethylamine (base component) at a total concentration of 25% by mass in ethylene glycol (solvent). The capacitor element was immersed in the electrolyte solution for 5 minutes in a reduced pressure atmosphere (40 kPa). Thus, the capacitor element (stacked body) was impregnated with the electrolyte solution.

### (f) Sealing of Capacitor Element

An electrolytic capacitor like that shown in FIG. 1 was produced by sealing the capacitor element impregnated with the electrolyte solution. Thereafter, aging was performed at 95° C. for 90 minutes while applying a voltage to the electrolytic capacitor. Thus, the electrolytic capacitor (capacitor A1) was obtained.

### (Capacitor A2)

An electrolytic capacitor (capacitor A2) was produced using the following method.

### (a) Preparation of Constituent Members

Constituent members were prepared in the same manner as in the production of the capacitor A1.

(b) Preparation of Dispersion (cd1)

A dispersion (cd1) was prepared using the same method and under the same conditions as for the production of the dispersion (d1), except that no insulating fibers were added.

### (c) Formation of Conductive Polymer Layer

Conductive polymer layers were formed on the dielectric layers on both surfaces of the anode foil, and on both surfaces of the cathode foil, using the dispersion (d1) in the same manner as in the production of the capacitor A1. Furthermore, a conductive polymer layer was formed on the separator in the same manner as in the production of the capacitor A1, except that the dispersion (cd1) was used instead of the dispersion (d1).

### (d) Production of Capacitor A2

Thereafter, a capacitor element was produced, impregnated with a liquid component was performed, and the capacitor element was sealed in the same manner as in the production of the capacitor A1. Thus, the capacitor A2 was produced.

### (Production of Capacitor C1)

A capacitor C1 was produced in the same manner as the capacitor A1, except that the dispersion used to form the conductive polymer layers on the constituent members was changed as shown in Table 1.

### (Evaluation)

The withstand voltage and equivalent series resistance (ESR) at 100 kHz were measured for each of the capacitors produced. The evaluation was performed by preparing three capacitors for each of the capacitors A1, A2, and C1, and calculating the arithmetic mean of their measured values.

Table 1 shows some of the conditions for forming the conductive polymer layers and the evaluation results. The capacitors A1 and A2 are the capacitors (E) according to the present embodiment, and the capacitor C1 is a capacitor according to a comparative example.

TABLE 1

| | Applied Dispersion | | | Evaluation | |
|---|---|---|---|---|---|
| | On | | | (Mean Value) | |
| | Dielectric | On Cathode | | Withstand | ESR |
| Capacitor | Layer | Foil | Separator | Voltage (V) | (mΩ) |
| A1 | d1 | d1 | d1 | 27.7 | 11.6 |
| A2 | d1 | d1 | cd1 | 32.5 | 12.6 |
| C1 | cd1 | cd1 | cd1 | 14.3 | 11.2 |

As shown in Table 1, the withstand voltage was improved by using the dispersion (d1) to which insulating fibers were added. Furthermore, the ESR of the capacitors A1 and A2 was almost the same as that of the comparative example C1. Thus, according to the present embodiment, an electrolytic capacitor capable of stably achieving high performance was obtained.

### INDUSTRIAL APPLICABILITY

The present disclosure is applicable to an electrolytic capacitor, a method for manufacturing the same, and a dispersion used for manufacturing an electrolytic capacitor.

Although the present invention has been described with respect to a presently preferred embodiment, such disclosure should not be interpreted as limiting the present invention. Various modifications and alterations will undoubtedly become apparent to those skilled in the art to which the present invention pertains upon reading the above disclosure. Therefore, the appended claims should be interpreted to include all modifications and alterations without departing from the true spirit and scope of the present invention.

### REFERENCE SIGNS LIST

10: capacitor element, 11: anode foil, 12: cathode foil, 13: separator, 14: winding end tape, 100: electrolytic capacitor, 101: bottomed case, 102: sealing member, 103: base plate

1. A dispersion used for manufacturing an electrolytic capacitor, comprising:
a conductive polymer; an insulating material; and a dispersion medium,
wherein the insulating material contains at least one kind of material selected from the group consisting of insulating fibers and insulating particles.

2. The dispersion according to claim 1, further comprising:
an additive containing hydroxy groups,
wherein the dispersion medium contains water, and
a ratio Mh/Mt is 0.03 or more, where Mh is a total formula weight of the hydroxy groups contained in the additive and Mt is a molecular weight of the additive.

3. The dispersion according to claim 1,
wherein the insulating fibers include a fiber containing at least one kind of material selected from the group consisting of cellulose, rayon, aramid, polyester, polyimide, and nylon.

4. The dispersion according to claim 1,
wherein the insulating particles include particles containing at least one kind of material selected from the group consisting of polyolefin, polyester, polytetrafluoroethylene, and ceramic.

5. A manufacturing method for manufacturing an electrolytic capacitor including an anode portion having a dielectric layer formed on a surface thereof, and a cathode portion, the manufacturing method comprising:
a step (X) of disposing a conductive polymer and an insulating material between the dielectric layer and the cathode portion,
wherein the insulating material contains at least one kind of material selected from the group consisting of insulating fibers and insulating particles.

6. The manufacturing method according to claim 5,
wherein the step (X) includes:
a step (a) of applying a first dispersion containing the conductive polymer, the insulating material, and a dispersion medium to the dielectric layer and drying the first dispersion, thereby causing the conductive polymer and the insulating material to adhere to a surface of the dielectric layer.

7. The manufacturing method according to claim 5,
wherein the electrolytic capacitor further includes a separator disposed between the dielectric layer and the cathode portion, and
the step (X) includes:
a step (X1) of applying a first dispersion containing the conductive polymer, the insulating material, and a dispersion medium to at least one element selected from the group consisting of the dielectric layer, the cathode portion, and the separator, and drying the first dispersion, thereby causing the conductive polymer and the insulating material to adhere to the at least one element; and
a step (X2) of stacking the anode portion, the separator, and the cathode portion to form a stacked body, the step (X1) and the step (X2) being carried out in the stated order.

8. The manufacturing method according to claim 7, further comprising:
a step (Z) of impregnating the stacked body with a liquid component after the step (X).

9. The manufacturing method according to claim 8, further comprising:
after the step (X) and before the step (Z),
a step (Y1) of impregnating the stacked body with a treatment liquid containing water and an organic compound with two or more hydroxyl groups; and
a step (Y2) of evaporating at least a portion of the water in the treatment liquid.

10. The manufacturing method according to claim 5,
wherein the step (X) includes:
a step (b1) of applying a second dispersion containing the insulating material to the dielectric layer and drying the second dispersion, thereby causing the insulating material to adhere to a surface of the dielectric layer; and
a step (b2) of applying a third dispersion containing the conductive polymer to the dielectric layer to which the insulating material has adhered, and drying the third dispersion, thereby causing the conductive polymer to adhere to the dielectric layer to which the insulating material has adhered, the step (b1) and the step (b2) being carried out in the stated order.

11. An electrolytic capacitor comprising:
an anode portion having a dielectric layer formed on a surface thereof;
a cathode portion; and
a conductive polymer and an insulating material disposed between the dielectric layer and the cathode portion,
wherein the insulating material contains at least one kind of material selected from the group consisting of insulating fibers and insulating particles.

12. The electrolytic capacitor according to claim 11, further comprising:
an additive disposed between the dielectric layer and the cathode portion,
wherein the additive contains hydroxy groups, and
a ratio Mh/Mt is 0.03 or more, where Mh is a total formula weight of the hydroxy groups contained in the additive and Mt is a molecular weight of the additive.

13. The electrolytic capacitor according to claim 11,
wherein at least a portion of the insulating material adheres to the dielectric layer.

14. The electrolytic capacitor according to claim 11, further comprising:
a stacked body formed of the anode portion, the cathode portion, and the separator disposed between the dielectric layer and the cathode portion,
wherein at least a portion of the insulating material adheres to at least one element selected from the group consisting of the dielectric layer, the cathode portion, and the separator.

15. The electrolytic capacitor according to claim 14,
wherein the stacked body is impregnated with a liquid component.
